(19) United States
(12) Patent Application Publication
(10) Pub. No.: US 2005/0088985 A1
(43) Pub. Date: Apr. 28, 2005

(54) METHOD FOR UPDATING DATA IN NON-VOLATILE MEMORY

(76) Inventors: Hung-Chun Yang, Taipei (TW); Ming-Hung Chang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/904,182

(22) Filed: Oct. 28, 2004

(30) Foreign Application Priority Data
Oct. 28, 2003 (TW) 92129878

(51) Int. Cl. H04Q 7/00

(52) U.S. Cl. 370/313

(57) ABSTRACT

A method for updating data in a non-volatile memory is provided. It is assumed that generally, the data to be written are sequential. After a pen drive receives a packet comprising to-be-updated data, it is determined whether the write-in address of the packet is in the same block with the last updated data to decide whether or not to copy back the un-updated data. Accordingly, unnecessary copy-back operations can be saved and the data updating efficiency can be improved.

### CROSS-REFERENCE TO RELATED APPLICATION

This application claims the priority benefit of Taiwan application serial no. 92129878, filed Oct. 28, 2003.

### BACKGROUND OF THE INVENTION

1. Field of the Invention

The present invention relates to a method for updating data, and more particularly, to a method for updating data in a non-volatile memory.

2. Description of the Related Art

In various memory media, pen drives have the advantages of small size, high capacity, and portability and have become increasingly popular. Generally, pen drives use flash memories installed therein for storing data. Flash memories comprise a plurality of blocks. Every block comprises a plurality of pages. Before data are written in the flash memory, where data were saved, these data stored in the block should be erased first. In the conventional method, the incoming data are written in the blank block, and the un-updated data stored in the original block are copied back to the newly written block. The address matching table, which matches the physical addresses to the logic addresses, is then updated to correspond the physical addresses to the block where the data are written.

FIG. 1 is a flowchart showing a conventional method for updating data in a pen drive. With reference to FIG. 1, in step S110, the packet comprising the to-be-updated data is received. In step S120, the to-be-updated data is written in a blank block and the un-updated data is copied back to the newly written block. In step S130, the address matching table is updated to correspond the physical addresses to the block where the data are written. However, in the conventional method, the un-updated data have to be copied back to the newly written block each time, and therefore the data-updating efficiency is low.

### SUMMARY OF THE INVENTION

Accordingly, the present invention is directed to a method for updating data in a non-volatile memory, wherein after the packet which comprises the to-be-updated data is received, the write-in address of the packet is checked to determine whether or not the un-updated data should be copied back. Accordingly, the data-updating efficiency can be improved.

In order to achieve the object described above, the present invention discloses a method for updating data, suitable for updating data in a non-volatile memory. The method includes receiving a data packet comprising the to-be-updated data. It is then determined whether or not a write-in address of the received packet is in a same block with a last-updated data, and whether or not the write-in address follows behind the last-updated data. When the write-in address of the packet is in the same block with the last-updated data and behind the last-updated data, the data of the packet are directly written in.

When the write-in address of the packet is in the same block with the last-updated data and behind the last-updated data, but the write-in address is not series behind an updated address of the last-updated data, the data of this non-series address are copied back and then the data of the packet are directly written in.

When the write-in address of the packet is in the same block with the last-updated data and in front of the last-updated data, the un-updated data are copied back, an address matching table is updated and the data of the packet are written in another block.

When the write-in address of the packet is not in the same block with the last-updated data, the un-updated data are copied back, an address matching table is updated and the data of the received packet are written in another block.

When no pocket is received in a preset time, the un-updated data are copied back and an address matching table is updated. Accordingly, even if the pen drive with the non-volatile memory is powered-off, the updated data can still be stored.

The present invention discloses a method for updating data, suitable for updating data in a non-volatile memory. The method includes receiving a packet comprising the to-be-updated data. It is then determined whether or not a write-in address of the packet is in a same block with a last-updated data, and whether or not the write-in address is at an address of un-updated data in the same block. The data of the packet are directly written when the write-in address of the packet is in the same block with the last-updated data and at the address of un-updated data.

When the write-in address of the packet is in the same block with the last-updated data but at the address of updated data, the un-updated data are copied back, an address matching table is updated and the data of the packet are written in another block.

When the write-in address of the packet is not in the same block with the last-updated data, the un-updated data are copied back, an address matching table is updated and the data of the packet are written in another block.

When no pocket is received in a preset time, the un-updated data are copied back and an address matching table is updated. Accordingly, even if the pen drive with the non-volatile memory is powered-off, the updated data are not lost.

Accordingly, the present invention provides a method for updating data in a non-volatile memory, wherein after the packet which comprises the to-be-updated data is received, the write-in address of the packet is checked to determine whether or not the un-updated data should be copied back. Since most of the data are written in series, the data of the packet can be written directly. Therefore, the data updating efficiency can be substantially improved.

In order to make the aforementioned and other objects, features and advantages of the present invention understandable, embodiments accompanied with figures are described in detail below.

### BRIEF DESCRIPTION OF THE DRAWINGS

FIG. 1 is a flowchart showing a conventional method for updating data in a pen drive.

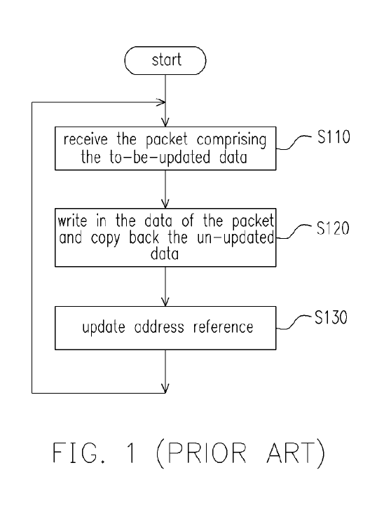

FIG. 2 is a flowchart showing a method for updating data in a non-volatile memory according to an embodiment of the present invention.

### DESCRIPTION OF THE EMBODIMENTS

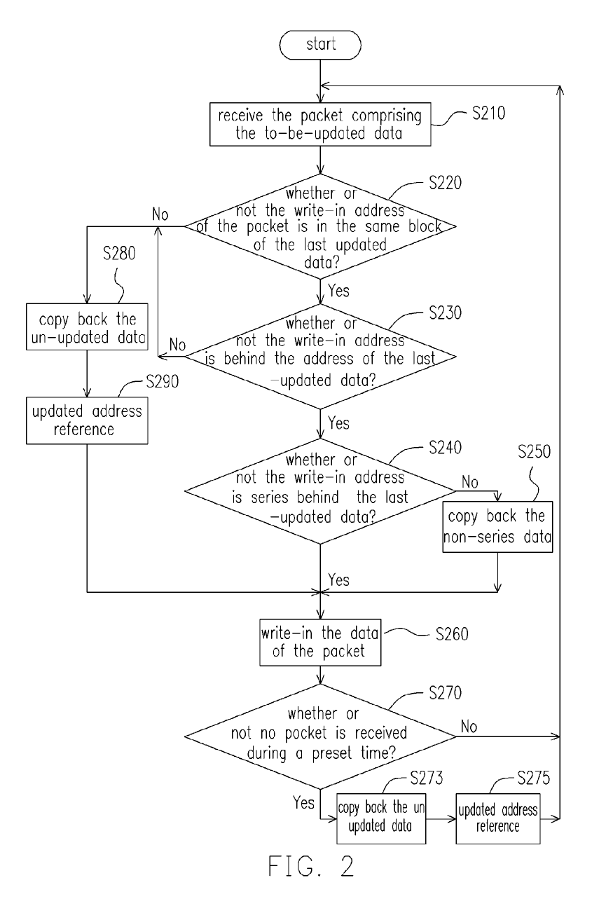

FIG. 2 is a flowchart showing a method for updating data in a non-volatile memory according to an embodiment of the present invention. With reference to FIG. 2, this embodiment is illustrated with a K9F1G flash memory in a pen drive, the flash memory comprising 128-Kbit block, which has 64 2-Kbit pages. In this embodiment, the data unit for the data packet of the pen drive is by pages, such as N pages.

As shown in FIG. 2, the pen drive receives the packet comprising the to-be-updated data in step S210. In step S220, it is determined whether or not the write-in address of the packet is in the same block with the last updated data. If not, step S280 is performed, where the un-updated is copied back to keep the data of the block intact. The address matching table is updated in step S290. That is, after address matching table for referring the physical addresses to the logic addresses is updated to refer the physical addresses to the updated data block, the data stored in the original block are erased. In step S260, an erased block is selected to store the data of the received packet.

For example, the last received packet is used to update the first block. In the last data updating process, the data are stored in the erased 11^{th} block. When the incoming packet is used to update the second block, the un-updated data stored in the first block are copied back to the 11^{th} block. The logic address corresponding to the first block is updated for referring to the 11^{th} block. The data stored in the first block are then erased for subsequent use. Then an erased block, such as the 12^{th} block, is selected and the data of the received packet are written therein.

In step S220, it is determined whether or not the write-in address of the packet is in a same block with the last-updated data. If so, step S230 determines whether the write-in address is behind the address of the last-updated data. If the write-in address is in front of the address of the last-updated data, steps S280 and S290 are performed to copy back the un-updated data and to update the address matching table. The step S260 is then performed to write the data of the received packet in another block.

For example, the last received packet is used to update pages 1-10 of the first block. In the last data updating process, the data are written in the erased 11^{th} block. The incoming packet is used to update pages 1-5 of the first block. The un-updated data stored in pages 11-64 of the first block are copied back to the 11^{th} block. The logic address corresponding to the first block is referred to the 11^{th} block. The data stored in the first block are then erased for subsequent use. Then an erased block, such as the 12^{th} block, is selected and the data of the received packet are written in pages 1-5. One of ordinary skill in the art should know that step S230 is required only when the pen drive uses a flash memory where data must be written sequentially. When using a flash memory where data can be written randomly, it only needs to determine whether the write-in address is at the address of the un-updated data.

The step S230 determines whether or not the write-in address is behind the address of the last-updated data. If so, step S240 determines whether the write-in address is series behind the last-updated data. If so, in step S260, the data of the receive packet are written. If the write-in address is not series with the address of the last-updated data, in step S250, the non-series data are copied back. Then the procedure goes to step S260, and the data of the received packet are then written.

For example, the last received packet is used to update pages 1-10 of the first block. In the last data updating process, the data are written in the erased 11^{th} block. The incoming packet is used to update pages 11-15 of the first block. The received data can be written in pages 11-15 of the 11^{th} block. If the incoming packet is used to update pages 16-20 of the first block, the data stored in pages 11-15 of the first block are copied back to the 11^{th} block and the data are then written in pages 16-20 of the 11^{th} block. One of ordinary skill in the art should know that steps S240 and S250 are required only when the pen drive uses a flash memory where data must be written sequentially. When using a flash memory where data can be written randomly, steps S240 and S250 can be spared.

To prevent data loss when the pen drive is powered-off while the up-updated data are being copied back, step S270 is added. When no packet is received during a preset time, the un-updated data are copied back and the address matching table is updated in steps S273 and S275 to maintain the integrity of the data.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. A method for updating data in a non-volatile memory, comprising:
receiving a packet comprising to-be-updated data;
determining whether or not a write-in address of the packet is in a same block with a last-updated data, and whether or not the write-in address is series behind the last-updated data; and
writing in data of the packet if the write-in address of the packet is in the same block with the last-updated data, and the write-in address is series behind the last-updated data.

2. The method of claim 1, further comprising copying back data of a non-series address and writing in the data of the packet when the write-in address of the packet is in the same block with the last-updated data, the write-in address is behind the last-updated data, but the write-in address is not series behind an address of the last-updated data.

3. The method of claim 1, further comprising copying back un-updated data, updating an address matching table and then writing the data of the packet in another block when the write-in address of the packet is in the same block with the last-updated data, and the write-in address is in front of the last-updated data.

4. The method of claim 1, further comprising copying back un-updated data, updating an address matching table and writing the data of the packet in another block when the write-in address of the packet is not in the same block with the last-updated data.

5. The method of claim 1, further comprising copying back un-updated data and updating an address matching table when no packet is received in a preset time.

6. A method for updating data in a non-volatile memory, comprising:
receiving a packet comprising to-be-updated data;
determining whether or not a write-in address of the packet is in a same block with a last-updated data, and whether or not the write-in address is at an address of un-updated data; and
writing-in data of the packet when the write-in address of the packet is in the same block with the last-updated data, and the write-in address is at an address of un-updated data.

7. The method of claim 6, further comprising copying back un-updated data, updating an address matching table and writing the data of the packet in another block when the write-in address of the packet is in the same block with the last-updated data, but the write-in address is not at the address of un-updated data.

8. The method of claim 6, further comprising copying back un-updated data, updating an address matching table and writing the data of the packet in another block when the write-in address of the packet is not in the same block with the last-updated data.

9. The method of claim 6, further comprising copying back un-updated data and updating an address matching table when no packet is received in a preset time.
